(19) United States
(12) Patent Application Publication
(10) Pub. No.: US 2002/0157657 A1
(43) Pub. Date: Oct. 31, 2002

(54) Dicing method and apparatus for cutting panels or wafers into rectangular shaped die

(75) Inventor: Eli Toledano, Haifa (IL)

Correspondence Address: RATNERPRESTIA, P O BOX 980, VALLEY FORGE, PA, 19482-0980, US

(73) Assignee: Kulicke & Soffa Investments Inc.

(21) Appl. No.: 09/841,745

(22) Filed: Apr. 25, 2001

(51) Int. Cl. B28D 1/04

(52) U.S. Cl. 125/15

(57) ABSTRACT

A method and apparatus for cutting panels or wafers into rectangular shaped die. The apparatus includes a spindle; and a first blade having a first diameter and a second blade having a second diameter smaller that the first diameter each blade mounted to the spindle and spaced apart from one another. The first blade and second blades cut the workpiece based on a direction of movement of said workpiece relative to the first and second blades. The method includes the steps of mounting a first blade having a first diameter and a second blade having a second diameter smaller that the first diameter on a spindle; moving the workpiece relative to the first and second blades; cutting the workpiece along a first direction with the first blade; and cutting the workpiece along a second direction with both the first and second blades simultaneously.

### FIELD OF THE INVENTION

This invention relates generally to saws of the type used in the semiconductor and electronics industry for cutting hard and brittle materials. More specifically, the present invention relates to a system and method for the high-speed formation of rectangular shaped die.

### BACKGROUND OF THE INVENTION

In the production of semiconductor devices, a surface of a nearly disc-like semiconductor wafer is divided into a plurality of areas by cutting lines (generally called streets) arranged in a lattice pattern, and a desired circuit pattern is applied to each of these areas. FIG. 1 is an isometric view of a semiconductor wafer 100 during the fabrication of semiconductor devices. A conventional semiconductor wafer 100 may have a plurality of chips, or dies, 100a, 100b, . . . formed on its top surface. The wafer is cut along the cutting lines 102, 104 to separate the individual rectangular areas having the circuit pattern applied thereto into chips 100a, 100b, etc. It is important that the cutting of the wafer 100 be carried out accurately along the cutting lines 102, 104.

Dicing saws for a variety of purposes, in particular for dicing and singulation of chip packages, such as ball grid array (BGA) type panels, are well known in the art. These saws generally include a wafer supporting means mounted rotatably and movably that passes under a rotating saw blade held by a spindle. Prior to the dicing process an alignment procedure is performed. Wafer alignment is carried out by positioning the wafer supporting means at a required position on the basis of the detection of the cutting lines. In this way, a specific cutting line on the surface of the wafer is accurately aligned with the path of the cutting movement. Additional cutting lines are then formed as necessary along the same direction by the cutting means. The positioning of the wafer supporting means includes rotating the wafer supporting means to position the wafer at a required angular position. Thereafter, the wafer supporting means is moved to the cutting station, under the rotating blade, and the cutting of the wafer is carried out. In this cutting, the cutting movement and a pitch movement, to linearly move the wafer supporting means and the cutting means relative to one another by the interval of the cutting lines in a direction perpendicular to the direction of the cutting movement, are alternately carried out. As a result, the wafer is cut along one set of cutting lines extending substantially parallel to one another. Subsequently, the wafer supporting means or cutting means is rotated substantially through 90 degrees, and the cutting movement and the pitch movement are alternately carried out again. As a result, the wafer is cut along the other set of cutting lines extending substantially parallel to one another and substantially perpendicularly to the aforesaid set of cutting lines. When the cutting of the wafer is complete, the cut wafer is taken out of the wafer supporting means and the next wafer to be cut is placed on the wafer supporting means.

The conventional dicing machine described above has a problem in that the dicing efficiency is low. Specifically, since the cutting means has only a single cutting blade, the wafer can be cut along only a single cutting line by a single cutting movement. Consequently, it is necessary to carry out the cutting movements a significant number of times, corresponding to the number of the cutting lines, in order to cut the wafer along a large number of cutting lines existing on the surface of the wafer. As a result, a considerable amount of time is dedicated to the cutting of the workpiece, resulting in a high cost of ownership to the customer.

In an attempt to overcome the above deficiencies, a dicing apparatus has been developed that includes a dual spindle system, with each spindle having a single dicing blade mounted thereto. Such an apparatus are disclosed in U.S. Pat. No. 4,688,540 to Ono and U.S. Pat. No. 5,842,461 to Azuma. These dicing apparatus are also deficient, however, since the blades must be moved relative to one another. As a result, it is necessary to maintain accurate alignment between the blades during the entire dicing operation. Furthermore, it is necessary to realign the blades of these apparatus when cutting the second set of streets, orthogonal to the first set of street, if the resulting dice are to be other than square. This realignment process is time consuming, thereby effecting efficiency of the dicing machine. Furthermore, device yield is negatively effected if the alignment between the blades is not constantly monitored and maintained during the entire dicing process. In addition, these systems require duplicative cutting and positioning assemblies. Thereby, significantly increasing the cost of these systems.

### SUMMARY OF THE INVENTION

In view of the shortcomings of the prior art, it is an object of the present invention to optimize the process of forming rectangular shaped dice from a semiconductor wafer or sheet in a cost-effective manner.

The present invention is a dicing saw system and method for optimizing the process for forming a plurality of rectangular shaped die. The system includes a spindle; a first blade having a first diameter; and a second blade having a second diameter smaller that the first diameter mounted to the spindle. The first blade and second blade cut the workpiece based on a direction of movement of the workpiece relative to the first and second blades.

According to another aspect of the invention, only the first blade cuts the workpiece when the workpiece is moved in a first direction, and the first and second blades each cut the workpiece when the workpiece is moved in a second direction.

According to still another aspect of the invention, a third blade is mounted on the spindle at the predetermined distance relative to either the first or second blades.

According to yet another aspect of the present invention, a spacer placed between the blades on the spindle controls the distance between the first and second blades.

According to a further aspect of the present invention, the distance between the first and second blades is adjustable.

According to yet a further aspect of the present invention, the workpiece is mounted on a translation table having a plurality of grooves in a surface thereof, the grooves along a first direction having a spacing corresponding to about twice the distance between the first and second blades, and the grooves along a second direction having a spacing corresponding to the distance between the first and second blades.

According to still another aspect of the invention, the system includes a spindle; and a plurality of blades mounted on the spindle and spaced at intervals relative to one another, with each odd numbered blade having a first diameter and each even numbered blade having a second diameter less than the first diameter. The odd or even positioned blades cutting the workpiece along a first direction and each of the plurality of blades cutting the workpiece along a second direction to form the plurality of rectangular die.

According to a further aspect of the invention, the method includes the steps of mounting a first blade having a first diameter, and a second blade having a second diameter smaller that the first diameter on a spindle; moving the workpiece relative to the first and second blades; cutting the workpiece along a first direction with the first blade; and cutting the workpiece along a second direction with both the first and second blades simultaneously.

These and other aspects of the invention are set forth below with reference to the drawings and the description of exemplary embodiments of the invention.

### BRIEF DESCRIPTION OF THE DRAWINGS

The invention is best understood from the following detailed description when read in connection with the accompanying drawing. It is emphasized that, according to common practice, the various features of the drawing are not to scale. On the contrary, the dimensions of the various features are arbitrarily expanded or reduced for clarity. Included in the drawing are the following Figures:

FIG. 1 is an isometric view of a semiconductor wafer used to form semiconductor devices;

FIG. 2 is a side view of a first exemplary embodiment of the present invention;

FIG. 3 is a side view of a second exemplary embodiment of the present invention;

FIG. 4 is a side view of a third exemplary embodiment of the present invention;

FIG. 5 is a side view of a fourth exemplary embodiment of the present invention;

FIG. 6 is a side view of a fifth exemplary embodiment of the present invention; and

FIGS. 7A and 7B are side views of an exemplary embodiment of the present invention performing dicing of a workpiece.

### DETAILED DESCRIPTION

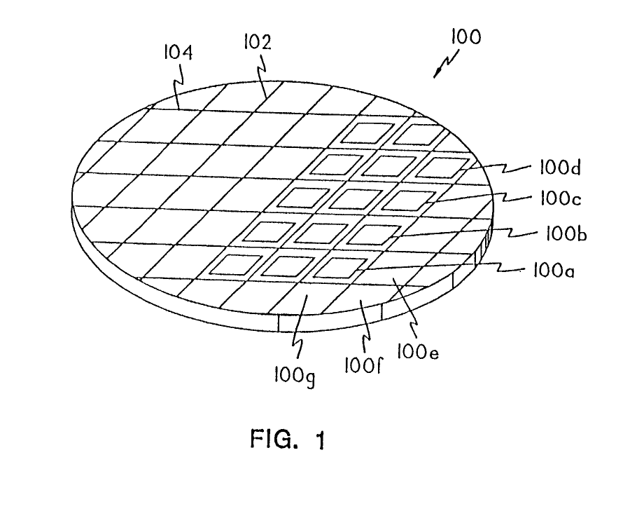

In the manufacture of semiconductor devices, individual chips are cut from a large wafer using a very high speed rotating saw blade. In essence, the saw blade grinds away a portion of the wafer along linear streets (102, 104 as shown in FIG. 1) in one direction followed by a second operation in an orthogonal direction.

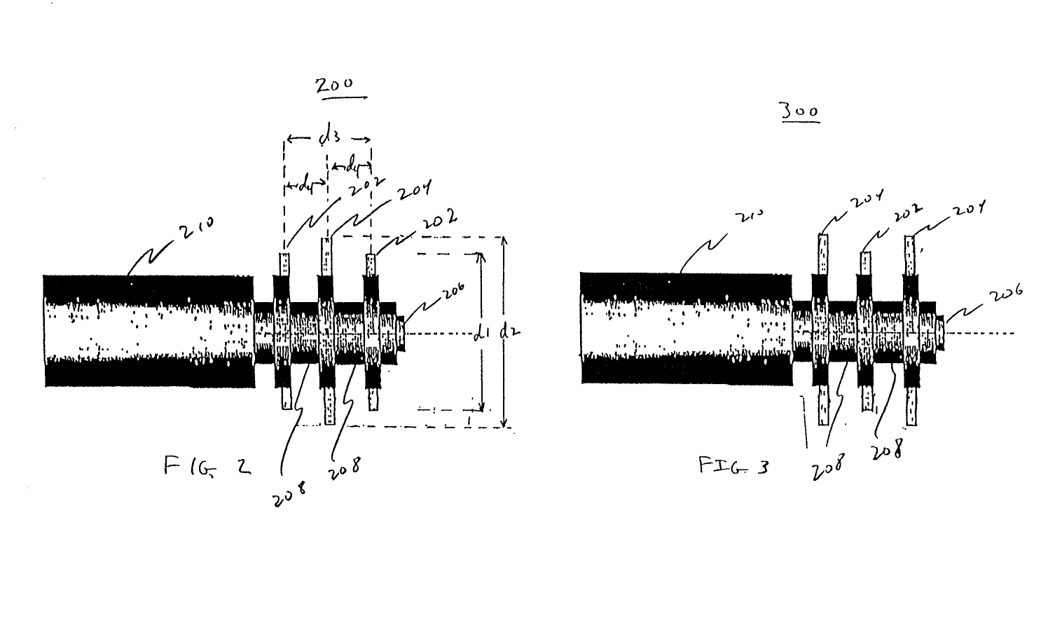

FIG. 2 illustrates a first exemplary embodiment of the present invention. In FIG. 2, dicing assembly 200 includes blades 202 and 204 mounted on spindle 206. Spindle 206 is coupled to motor 210 which rotates shaft 206 along its axis, in turn, rotating blades 202 and 204. In an exemplary embodiment, blades 202 and 204 are dicing blades, such as those used in the semiconductor industry and well known to those of skill in the art. The diameter d1 of blade 202 is less than the diameter d2 of blade 204. The difference between d1 and d2 is at least about half the thickness of the material being cut by the blades. The significance of this difference will become apparent in the description below. Blades 202 and 204 are spaced apart from one another on shaft 206 by distance x. One or more spacers 208, for example, maintain distance x between blades 202 and 204. The distance may be adjusted as desired by adding or removing additional spacers 208 of varying widths. In the exemplary embodiment, the spacing between adjacent blades 202-204 and 204-202 is equal.

In the first exemplary embodiment, blades 202 having diameter d1 are placed on opposite sides of blade 204 having larger diameter d2. The invention is not so limited, however, in that the larger diameter blade 204 may be placed on opposite sides of smaller diameter blade 202 as shown in FIG. 3 in a second exemplary embodiment of the present invention.

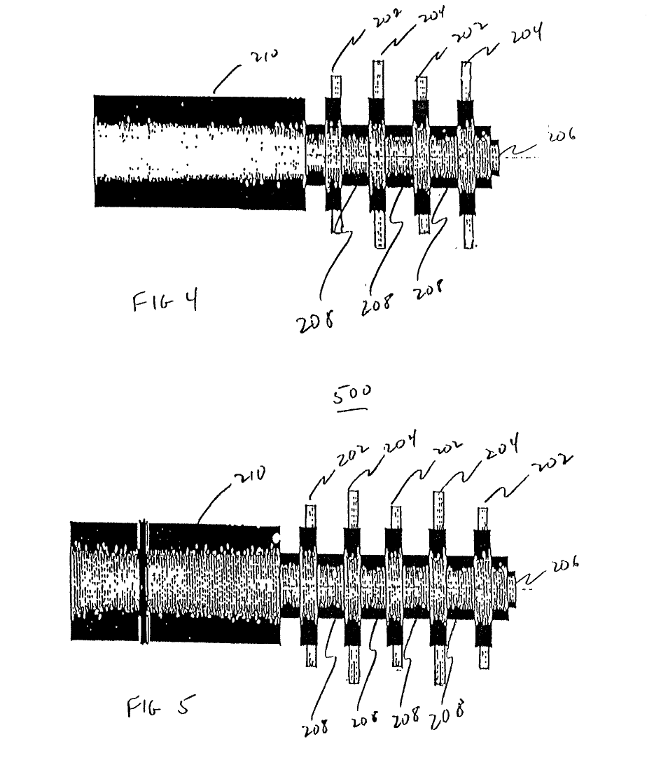

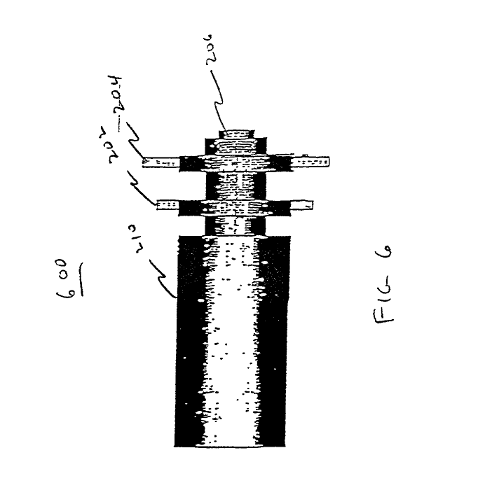

In the first exemplary embodiment, three blades are shown mounted on shaft 206. The invention is not so limited, however, in that only two blades may be mounted on shaft 206 as shown in FIG. 6, or more than three blades may be mounted on shaft 206 as shown in FIGS. 4 and 5. As readily understood by those skilled in the art, there is a practical limit on the number of blades that can be mounted on shaft 206 based on the amount of torque need to cut multiple lines simultaneously in the workpiece and the power of motor 210 in addition to possibly other process limitations.

In the exemplary embodiments of FIGS. 4, 5 and 6, the blades 202 and 204 are mounted in a configuration where the smaller diameter blade 202 is mounted closest to motor 210. The invention is not so limited, in that the order of the blades 202 and 204 may be reversed such that the larger diameter blade 204 may be closest to motor 210.

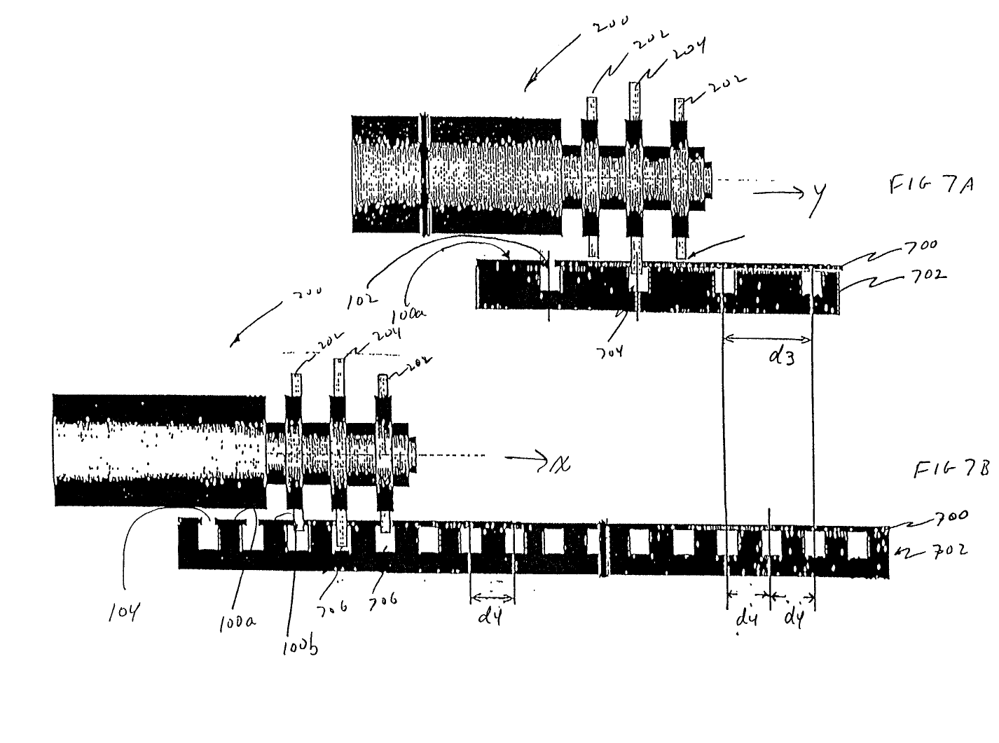

Referring to FIGS. 7A and 7B, the details of dicing a workpiece 700 into rectangular shaped dice is illustrated. In FIG. 7A, workpiece 700, which may be, for example, a semiconductor wafer or wafer package panel, such as a Ball Grid Array (BGA) panel, is mounted to a mounting surface 702. In the semiconductor industry, mounting surface 702 may be a chuck or part of a translation table for example. The workpiece 700 may be maintained in position on surface 702 by any one of a variety of means known to those of skill in the art, such as vacuum or adhesive tape, for example. As shown in FIG. 7A, surface 702 has apertures 704 formed within surface 702 corresponding to the position of blade 204 and spaced apart from one another by distance d3 corresponding to the length of dice 100a, 100b, etc. As shown in FIG. 7B, apertures 706 are formed within surface 702 corresponding to the position of blade 202 and 204, and spaced apart from one another by distance d4 corresponding to the width of dice 100a, 100b, etc. It is also contemplated that a resilient surface may be placed on surface 702 such that apertures 704, 706 may be eliminated or reduced in depth.

Dicing of workpiece 700 is performed in a first direction by bringing only the larger diameter blade 204 in contact with workpiece 700 to form cut 102 in workpiece 700. To move blade 204 and workpiece 700 toward one another, either assembly 200 is moved toward workpiece 700 or workpiece 700 is moved toward assembly 200. Alternatively, both assembly 200 and workpiece 700 may both be moved toward one another. The workpiece is then moved orthogonal to the axis of shaft 206 to complete to cut across workpiece 700. After the first cut 102 is formed in workpiece 700, assembly 200 is moved in direction y by a distance d3 and the cutting process is repeated.

After the first set of cuts 102 are formed across the surface of workpiece 700, workpiece 700 is rotated relative to assembly 200 by approximately 90°, for example, if rectangular dice are desired. Referring now to FIG. 7B, the completion of the process of forming dice 100a, 100b, etc. (shown in FIG. 1) is illustrated. Dicing of workpiece 700 is performed in a second direction by bringing both the larger diameter blade 204 and the smaller diameter blade 200 into contact with workpiece 700 to simultaneously form multiple cuts 104 in workpiece 700. The method of moving blades 202, 204 and workpiece 700 toward one another is the same as above 30 and, therefore, not repeated here. Workpiece 700 is then moved orthogonal to the axis of shaft 206 to complete the cut across workpiece 700. After the first set of cuts 104 is formed in workpiece 700, assembly 200 is moved in direction x by a distance equivalent to the multiple of the number of blades 202, 204 and the spacing d4 between adjacent blades, and the cutting process is repeated. The result is a plurality of rectangular dice 100a, 100b, etc., having dimensions about d3 long by d4 wide.

It is clear from the description above, that the formation of cuts 102, 104 in workpiece 700 to form rectangular dice is performed more rapidly than in conventional dicing systems. Therefore, throughput is increased and the cost per die is decreased.

Although the invention has been described with reference to exemplary embodiments, it is not limited thereto. Rather, the appended claims should be construed to include other variants and embodiments of the invention which may be made by those skilled in the art without departing from the true spirit and scope of the present invention.

What is claimed:

1. A device for producing a plurality of rectangular shaped die from a workpiece, the device comprising:
a spindle; and
a first blade having a first diameter and a second blade having a second diameter smaller that the first diameter, each blade mounted on the spindle at a predetermined interval relative to one another,
wherein the first blade and second blade cut the workpiece based on a direction of movement of said workpiece relative to the first and second blades.

2. The device according to claim 1, wherein only the first blade cuts the workpiece when the workpiece is moved in a first direction relative to the first and second blade, and the first and second blades each cut the workpiece when the workpiece is moved in a second direction relative to the first and second blade.

3. The device according to claim 1, further comprising a third blade mounted on the spindle at the predetermined distance relative to one of the first and second blades.

4. The device according to claim 1, wherein the predetermined distance is based on a spacer placed between the blades on the spindle.

5. The device according to claim 4, wherein the predetermined distance is adjustable.

6. The device according to claim 1, wherein the difference in the diameters of the first blade and the second blade is at least twice a thickness of the workpiece.

7. The device according to claim 1, further comprising means for moving the first and second blades toward a surface of the workpiece.

8. The device according to claim 1, further comprising a table for mounting and moving the workpiece relative to the first and second blades.

9. The device according to claim 8, wherein the table is a translation table having a resilient surface, the blades contacting at the resilient surface as the workpiece is being cut.

10. The device according to claim 8, wherein the table is a translation table having a plurality of grooves in a surface thereof, a distance between the grooves corresponding to a respective spacing between adjacent streets on the workpiece.

11. The device according to claim 1, wherein workpiece is a one of a semiconductor substrate, a BGA panel, and a microelectronic device.

12. A device for producing a plurality of rectangular shaped die from a workpiece, the device comprising:
a spindle; and
a plurality of blades mounted on the spindle at a predetermined interval relative to one another, each odd numbered blade having a first diameter and each even numbered blade having a second diameter less than the first diameter,
wherein predetermined ones of the plurality of blades cut the workpiece along a first direction and each of the plurality of blades cut the workpiece along a second direction to form the plurality of rectangular die.

13. The device according to claim 14, wherein workpiece is a one of a semiconductor substrate, a BGA panel, and a microelectronic device.

14. A device for producing a plurality of rectangular shaped die from a workpiece, the device comprising:
a spindle; and
a plurality of blades mounted on the spindle at a predetermined interval relative to one another, each even numbered blade of the plurality of blades having a first diameter and each odd numbered blade of the plurality of blades having a second diameter less than the first diameter,
wherein the even numbered blades of the plurality of blades cut the workpiece along a first direction and each of the plurality of blades cut the workpiece along a second direction to form the plurality of rectangular die.

15. The device according to claim 14, wherein workpiece is a one of a semiconductor substrate, a BGA panel, and a microelectronic device.

16. A method for producing a plurality of rectangular shaped die from a workpiece, the method comprising the steps of:
mounting a first blade having a first diameter and a second blade having a second diameter smaller that the first diameter on a spindle, each blade mounted at a predetermined interval relative to one another;
moving the workpiece relative to the first and second blades;
cutting the workpiece along a first direction with the first blade; and
cutting the workpiece along a second direction with both the first and second blades simultaneously, the second direction substantially orthogonal to the first direction.

17. The method according to claim 16, wherein workpiece is a one of a semiconductor substrate, a BGA panel, and a microelectronic device.

18. A method for producing a plurality of rectangular shaped die from a workpiece, the method comprising the steps of:
mounting a plurality of blades on a spindle at a predetermined interval relative to one another, each blade in an odd position having a first diameter and each blade in an even position having a second diameter smaller that the first diameter on a spindle;
cutting the workpiece along a first direction with the blades mounted in the odd positions on the spindle; and
cutting the workpiece along a second direction with the plurality of blades simultaneously, the second direction substantially orthogonal to the first direction.

19. The method according to claim 18, wherein workpiece is a one of a semiconductor substrate, a BGA panel, and a microelectronic device.

20. A method for producing a plurality of rectangular shaped die from a workpiece, the method comprising the steps of:
mounting a plurality of blades on a spindle at a predetermined interval relative to one another, each blade in an odd position having a first diameter and each blade in an even position having a second diameter smaller that the first diameter on a spindle;
cutting the workpiece along a first direction with the blades mounted in the even positions on the spindle; and
cutting the workpiece along a second direction simultaneously with the plurality of blades, the second direction substantially orthogonal to the first direction.

21. The method according to claim 20, wherein workpiece is a one of a semiconductor substrate, a BGA panel, and a microelectronic device.

22. A device for producing a plurality of rectangular shaped die from a BGA panel, the device comprising:
a spindle; and
a first blade having a first diameter and a second blade having a second diameter smaller that the first diameter, each blade mounted on the spindle at a predetermined interval relative to one another,
wherein the first blade and second blades cut the panel based on a direction of movement of the panel relative to the first and second blades.
